(19) United States
(12) Patent Application Publication
(10) Pub. No.: US 2008/0179898 A1
(43) Pub. Date: Jul. 31, 2008

(54) Modular latch assembly

(76) Inventors: Douglas L. Juga, Kenosha, WI (US); Charles E. Bullock, Waukegan, IL (US)

Correspondence Address: BRINKS HOFER GILSON & LIONE, P.O. BOX 10395, CHICAGO, IL, 60610, US

(21) Appl. No.: 11/699,917

(22) Filed: Jan. 30, 2007

(51) Int. Cl. E05C 3/14; B60J 7/185

(52) U.S. Cl. 292/254; 296/136.01

(57) ABSTRACT

A latch assembly includes a mounting member having opposite first and second terminal end portions spaced apart in a longitudinal direction and an actuator coupled to the mounting member. One or more extension members having a terminal end portion are secured to one of the terminal end portions of the mounting member. One or more latch devices are coupled to the extension member at a location longitudinally spaced from the terminal end portion of the extension member. The latch device is operable between a latched and unlatched position. The latch device is operatively coupled to the actuator and is moveable between the latched and unlatched positions as the actuator is operated between a first and second position. A latch device includes a housing and a guide member adjustably moveable relative to the housing in a first direction. The guide member has an opening extending along a second direction substantially perpendicular to the first direction. A latch component extends through and is reciprocally moveable in the second direction between at least an engaged position and a disengaged position. An actuator is operably coupled to and is operable to move the guide member in the first direction relative to the housing.

### FIELD OF THE INVENTION

The present invention relates generally to a latch assembly, and in particular, to a latch assembly assembled from modular components.

### BACKGROUND

Typically, latch assemblies for panels, such as building doors, tonneau covers (pickup bed covers), etc. are assembled piece-meal. For example, two latch devices can be secured to opposite sides of the panel, with a central actuator mechanism secured separately to the middle of the panel. The actuator mechanism is then connected to the latch devices with rods or cables. This type of assembly requires skilled workers to properly position and secure each of the actuator and latch devices and linking components. In addition, a relatively large amount of time can be required to assemble each panel with the latch assembly.

In addition, latch assemblies are typically configured with an engagement member that engages a particular latch receiving structure located at a particular position relative to the latch assembly. Typically, such latch assemblies are not adjustable, and are thereby not suitable for engaging different latch receiving structures, or latch receiving structures located at different positions relative to the latch assembly.

### SUMMARY

The present invention is defined by the following claims, and nothing in this section should be considered to be a limitation on those claims. By way of introduction, the embodiment of a latch assembly described below may be connected to any component for engagement with another component. For example and without limitation, the latch assembly can be mounted on any panel, such as a lid, door, cover (e.g., tonneau), etc. that moves relative to a support component, such as a frame, truck bed, etc. having a latch receiving/engaging element so as to secure the panel to the support component.

In one embodiment, the latch assembly includes a mounting member having opposite first and second terminal end portions spaced apart in a longitudinal direction and an actuator coupled to the mounting member. The actuator is operable between at least a first and second position. A first extension member has opposite first and second terminal end portions spaced apart a first fixed distance in the longitudinal direction, with the first terminal end portion of the first extension member fixedly, non-moveably coupled to the first terminal end portion of the mounting member. A second extension member has opposite first and second terminal end portions spaced apart a second fixed distance in the longitudinal direction, with the first terminal end portion of the second extension member fixedly, non-moveably coupled to the second terminal end portion of the mounting member.

A first latch device is coupled to the first extension member at a first location longitudinally spaced from the first terminal end portion of the first extension member. The first latch device is operable between a latched and unlatched position. A second latch device is coupled to the second extension member at a second location longitudinally spaced from the first terminal end portion of the second extension member. The second latch device is operable between a latched and unlatched position. The first and second latch devices are operatively coupled to the actuator and are moveable between the latched and unlatched positions as the actuator is operable between said first and second positions.

In another aspect, one embodiment of a modular latch assembly kit includes a mounting member having opposite first and second terminal end portions and an actuator adapted to be coupled to the mounting member. The actuator is operable between at least a first and second position. A plurality of extension members each have first and second terminal end portions defining a length therebetween. The length of at least one of the plurality of extension members is different than the length of at least another of the plurality of extension members. Each of the plurality of extension members are configured to be coupled to at least one of the first and second terminal end portions of the mounting member. A latch device is adapted to be coupled to at least one of the plurality of extension members.

In yet another aspect, one embodiment of a method of assembling a modular latch assembly includes providing a mounting member having opposite first and second terminal end portions spaced apart in a longitudinal direction, providing an actuator and coupling the actuator to the first mounting member. The method further includes providing a first extension member and coupling the first extension member to the first terminal end portion of the mounting member such that the first extension member extends from the mounting member in the longitudinal direction. The method further includes providing a second extension member and coupling the second extension member to the second terminal end portion of the mounting member such that the second extension member extends from the mounting member in the longitudinal direction. The method further includes providing first and second latch devices, coupling the first and second latch devices to the first and second extension members respectively, and operably coupling the first and second latch devices to the actuator.

In another aspect, a latch device includes a housing having an opening elongated in at least a first direction and a guide member adjustably moveable relative to the housing in the first direction. The guide member has an opening substantially aligned with the elongated opening in the housing as the guide member is moved relative to the housing. An actuator is operably coupled to the guide member to move the guide member in the first direction relative to the housing. In one preferred embodiment, a latch component, preferably configured as a rod, extends through the opening in the guide member. A rod is moveable through the elongated opening in the housing for engagement with a latch-receiving structure. A method of using the latch device is also provided.

The various aspects and embodiments provide significant advantages. In particular, the latch assembly can be easily and quickly assembled at the manufacturer as a self-contained assembly. The assembly can then be easily transported and secured to a panel without having to individually position and secure the actuator and latch devices. At the same time, the overall length of the assembly can be quickly and easily changed simply by changing the length of one or both of the extension mounting members. Likewise, the assembly can be easily customized by installing various selected actuators suitable for different end users.

The modular latch device also provides significant advantages. In particular, the height of the latch component can be easily and quickly changed simply by moving the guide member and rod relative to the housing, such that the rod extends from the housing at a different location or height. In this way, the latch device is modular and can be used with a variety of structures and latch receiving devices that are positioned at different distances relative to one another.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1A is a partial perspective view of a truck having a cover with a latch assembly secured to the cover.

FIG. 1B is a partial perspective view of a building structure having a door with a latch assembly secured to the door.

FIG. 2 is an exploded view of a latch assembly.

FIG. 3 is an enlarged partial and exploded bottom view of a middle portion of the latch assembly shown in FIG. 2.

FIG. 4 is an enlarged partial and exploded top view of a middle portion of the latch assembly shown in FIG. 2.

FIG. 5 is an enlarged partial and exploded perspective view of a middle portion of the latch assembly shown in FIG. 2.

FIG. 6 is an enlarged partial and exploded perspective view of an end portion of the latch assembly shown in FIG. 2.

FIG. 7 is a perspective view of an alternative embodiment of a latch device.

FIG. 8 is an end view of the latch device shown in FIG. 7 with the cover removed.

FIG. 9 is a perspective view of a latch assembly incorporating the latch device of FIG. 7, with the cover in a closed configuration.

FIG. 10 is a perspective view of the latch assembly shown in FIG. 9 without an actuator mechanism shown.

FIG. 11 is a cross-sectional view of a unitary mounting member taken along line 11-11 of FIG. 10.

FIG. 12 is an end view of a cover taken along line 12-12 of FIG. 10.

FIG. 13 is a top view of a third embodiment of a latch assembly without a cover shown.

### DETAILED DESCRIPTION OF THE PRESENTLY PREFERRED EMBODIMENTS

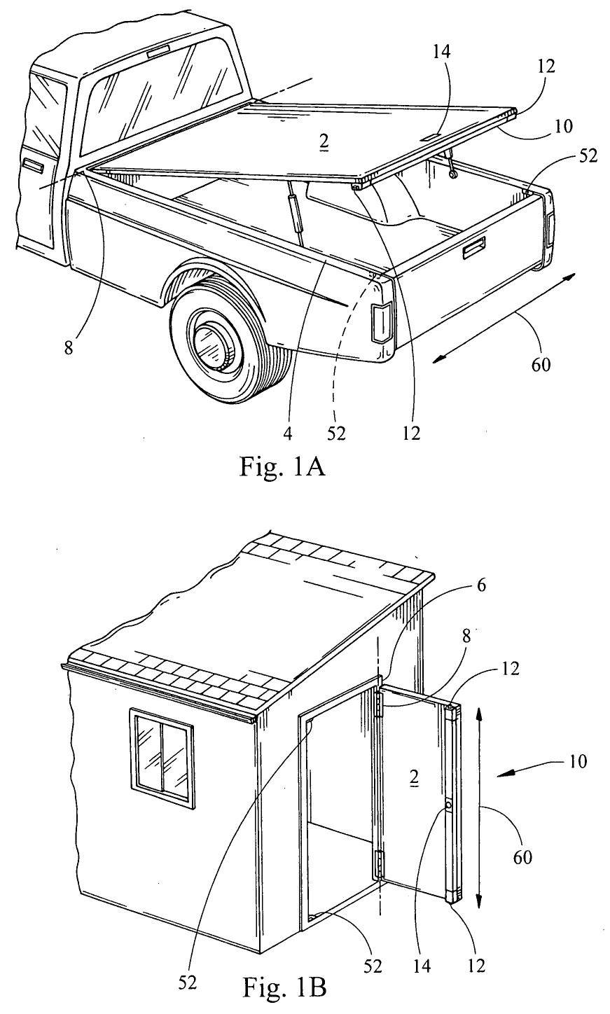

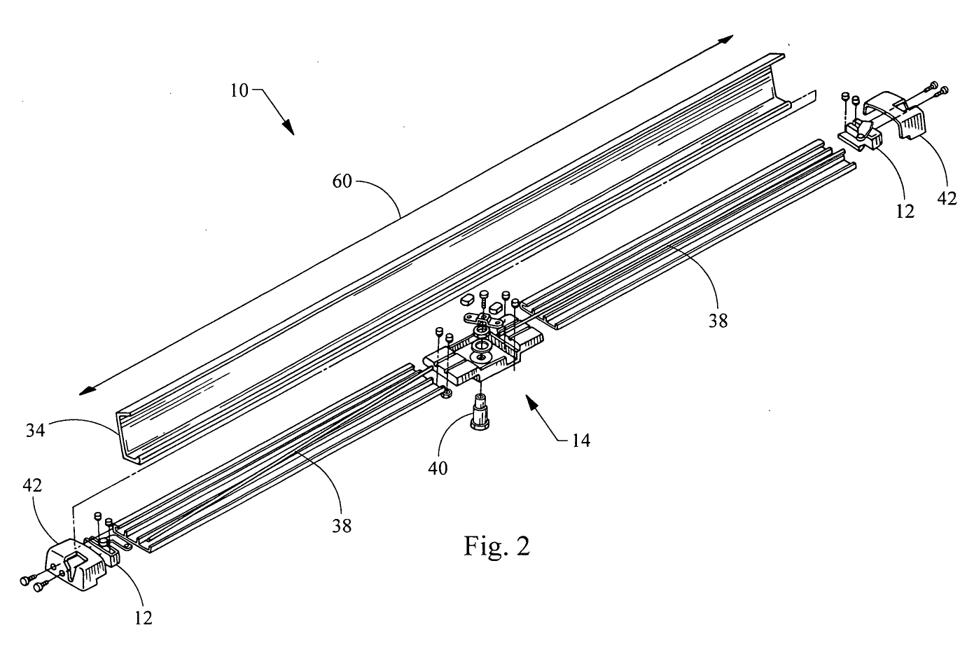

Referring to FIGS. 1A and B, a modular latch assembly 10 is secured to a panel 2, which can take many different forms. For example and without limitation, the panel 2 can be configured as a lid, cover, door, etc., and is shown as a tonneau cover in FIG. 1A and as a door in FIG. 1B. The panel is moveably connected to the support structure 4, 6, shown for example and without limitation as a frame 6, truck bed 4, or other fixed structure. In various embodiments, the panel 2 is hingedly connected to the support structure 4, 6 along a pivot axis 8, for example with a hinge, or can be completely removed therefrom free of any connection. In a preferred embodiment, the support structure has a latch engaging or receiving element 52 coupled thereto for engagement with the latch assembly when the panel 2 is moved to a closed position from an open position. The latch assembly extends in a longitudinal direction 60 and can be configured for use in a horizontal orientation, for example on a tonneau cover as shown in FIG. 1A, or in vertical orientation, for example on an entry door as shown for example in FIG. 1B. Of course, it should be understood that the latch assembly can be used with any component requiring latching, including for example and without limitation tool or other boxes, hatches, storage containers, skylights, etc.

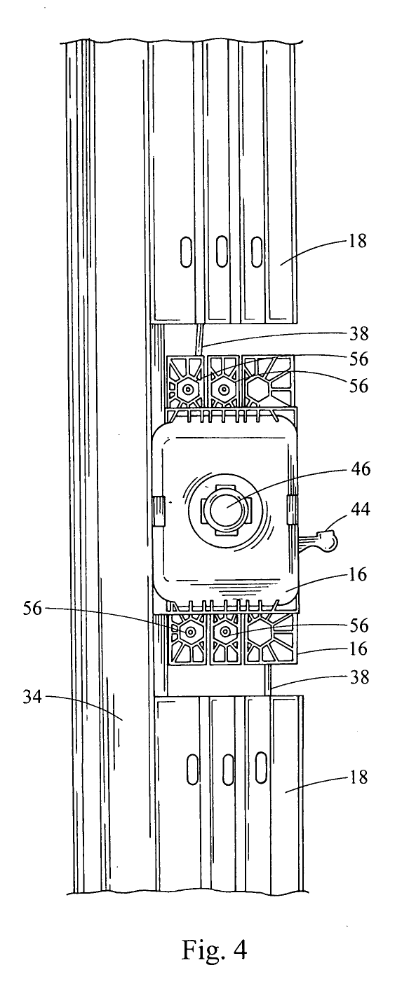

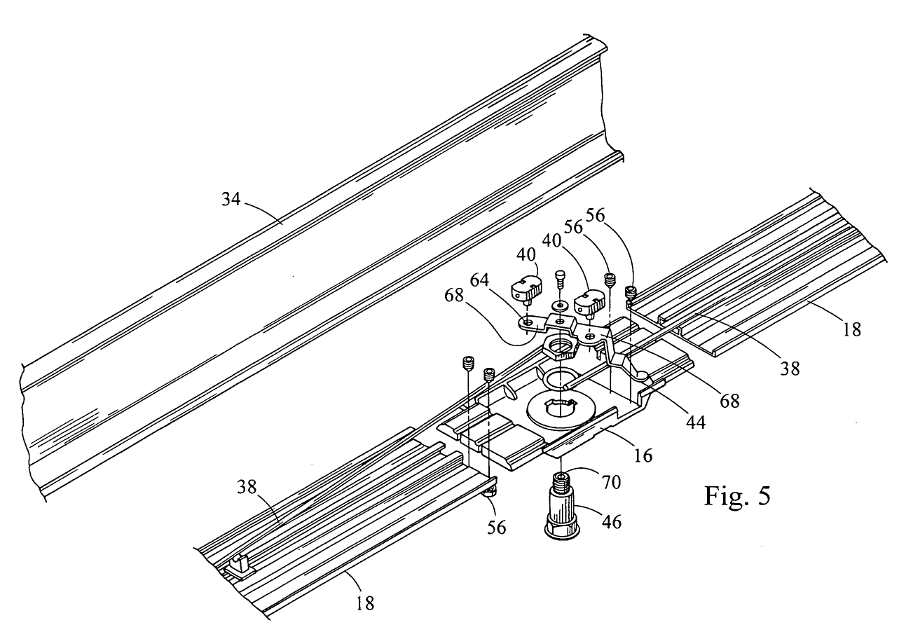

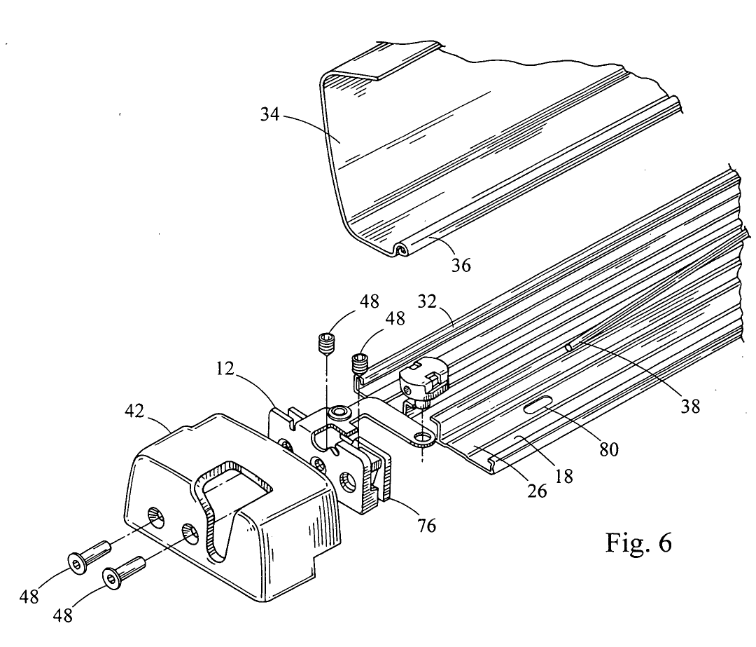

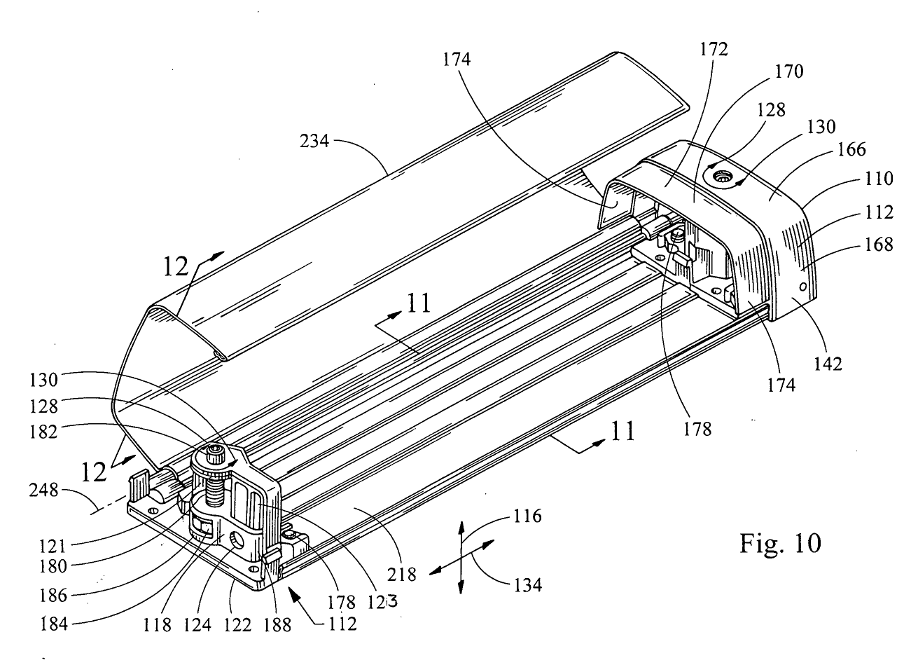

Referring to FIGS. 2-8, the latch assembly 10 includes several modular components, namely a base mounting member 16, two extension members 18, otherwise referred to as mounting members, a pair of linking members 28 and a pair of latch devices 12, 112. It should be understood that the latch assembly could be configured with only one extension member and linking member. Alternatively, as shown in FIG. 10, a single extension member 218 extends the entire length of the latch assembly. Referring to FIGS. 2-8, the extension members 18, 118 are preferably formed from an extrusion, which can be easily cut (along with the linking members 38, preferably formed as actuator rods) to different lengths to provide different length assemblies. In another embodiment, shown in FIGS. 10 and 11, the extension member(s) 218 are roll-formed so as to form a predetermined cross-sectional profile. When cut, the extension members of FIGS. 2-8 have first and second terminal end portions 24, 26 that are spaced apart a fixed distance in the longitudinal direction 60. The extension members are formed with a cross-sectional profile, best shown in FIGS. 5 and 6, which forms one or more openings or recesses 30 opening outwardly at each terminal end portion 24, 26. The profile also forms a hinge element 32 along one edge of the extension member 18. In a preferred embodiment, the extension members are preferably formed of a metal, such as aluminum or steel, although they can be also formed from a plastic and/or composite material. As previously mentioned, any of the extension members can be made formed by extrusion or roll-forming, or any other process such as molding, etc., that forms a desired cross-sectional profile.

For example, as shown in FIG. 1, one roll-formed cross-section is shown, with the left-hand side forming a first hinge component 232, or opening, and with the right-hand side forming a flexible, curved retainer flange 234, with an outer concave surface 242. As shown in FIGS. 10 and 12, a cover 234 is also roll formed, with the left-hand side forming a second hinge component 236 shaped and dimensioned to be received in the first hinge component 232 for rotational movement relative thereto. The right hand side of the cover terminates in an inwardly folded edge portion 238 having a concave-inward surface 240 and an enlarged edge portion 244 shaped to mate with the retainer flange 234 of the mounting member. In this way, the cover can be rotated about a rotational axis 248 from an open position to a closed position, wherein the edge portion 238 resiliently and releasably engages the retainer flange 234 with a snap-fit, or friction-fit.

Referring to the embodiment of FIGS. 2-6 and 9, the flip cover 34, which is optional to provide improved aesthetics and protection from the ambient environment, is pivotally connected to one side of the extension and/or center mounting members 18, 16. The flip cover includes an enlarged edge portion 36, that forms a hinge component that is shaped to pivotally mate with the hinge component 32 formed, for example, by the cross-sectional profile of the extruded extension members 18. The flip cover 34 can be pivoted from an open position, wherein at least a portion of an actuator mechanism 14, the linking members 38 and/or one or more latch devices 12 are exposed, to a closed position, wherein at least a portion of the actuator mechanism, linking members and/or latch devices are covered, which can improve the aesthetics of the assembly. In the open position, the interior components are exposed, for example, to allow for adjusts, repair or replacement of the components.

Referring to the embodiment of FIGS. 2-5, the center or base mounting member 16 also has first and second terminal edge portions 20, 22 spaced apart along the longitudinal direction or axis 60. Each terminal end portion 20, 22 is configured with one or more insert portions 28, shown as tabs, that are shaped to be slidably received in the openings or recesses 30 formed in the ends of the extruded extension members 18. It should be understood in an alternative embodiment, the base member is configured with openings and the extension members are configured with insert portions that are shaped to be received in the openings. After the insert portions 28 are disposed in the openings, one or more fasteners 56 are installed to releasably secure the extension members 18 to the center mounting member 16. It should be understood that in other embodiments, the extension members can be secured to the mounting member without mating insert/openings, for example and without limitation with fasteners, welding, snap-fit tabs, etc., or combinations thereof.

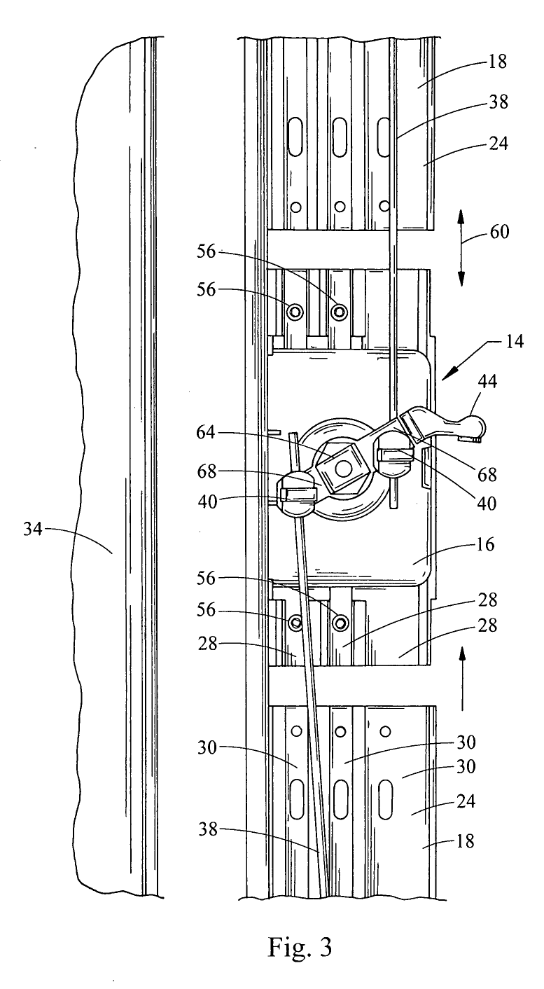

Referring to FIGS. 3 and 5, in one embodiment, the actuator mechanism 14 includes an actuator 46, such as a lock cylinder, handle or push button. In one embodiment, the actuator 46 is connected to a rotating member 64, which in turn has arm portions 68 with opposite ends connected to end portions of the linking members 38, or actuator rods, for example with clamps 40. One or both of the arm portions are configured with an extension 44, which can be operated as an interior release, for example by a person inadvertently shut inside the vehicle bed or building.

In operation, the actuator 46 is operated between a first and second position such that the rotating member 64 is rotated about an axis 70. As the rotating member 64 rotates, the arms 68 thereof rotate and thereby translate the rods 38 in a longitudinal direction 60. Opposite, outer ends of the rods 38 are coupled to a pair of latch devices 12 respectively with additional clamps 40 as shown in FIG. 6. It should be understood that moving the actuator from or between a first position and a second position includes pushing a push button in and releasing the button.

The latch devices 12 are coupled to the extension members, for example at the opposite terminal ends 26 thereof with one or more fasteners and adjacent the sides of the cover 34 for engagement with the latch engaging members 52, located for example on the support structure 4, 6. The latch devices 12 each include a latch component 76 that can be moved from an engaged position to a disengaged position as the rods 38 are moved by the actuator 46 and rotating member 64. The latch devices can be covered with optional end covers 42 to improve the aesthetics thereof. The covers are secured to the latch device 12 with fasteners 48. The covers have an opening 78 formed therein such that the latch receiving/engaging element 52 can be engaged by the latch component 76 as the latch device is moved from the disengaged position to the engaged position. One suitable latch device is the ALH 425 latch available from A.L. Hansen Manufacturing, the Assignee of the present application. Of course, other latch devices would also work.

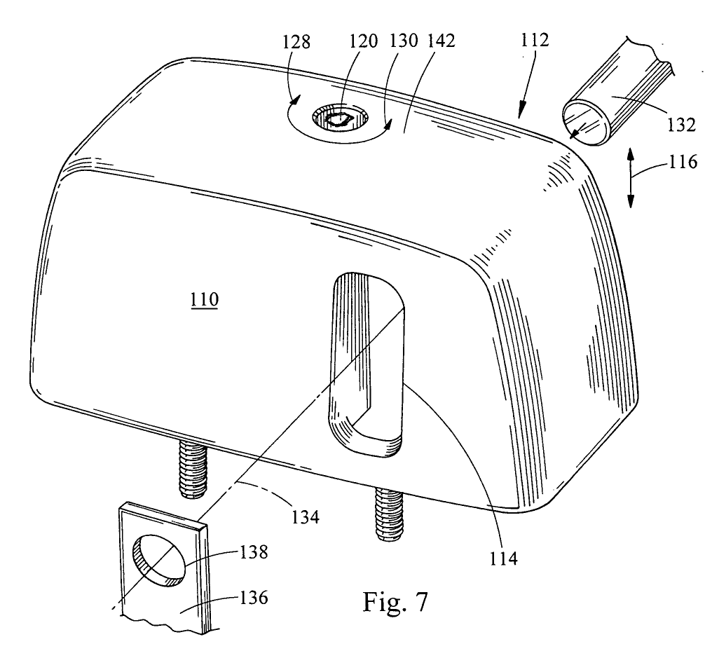

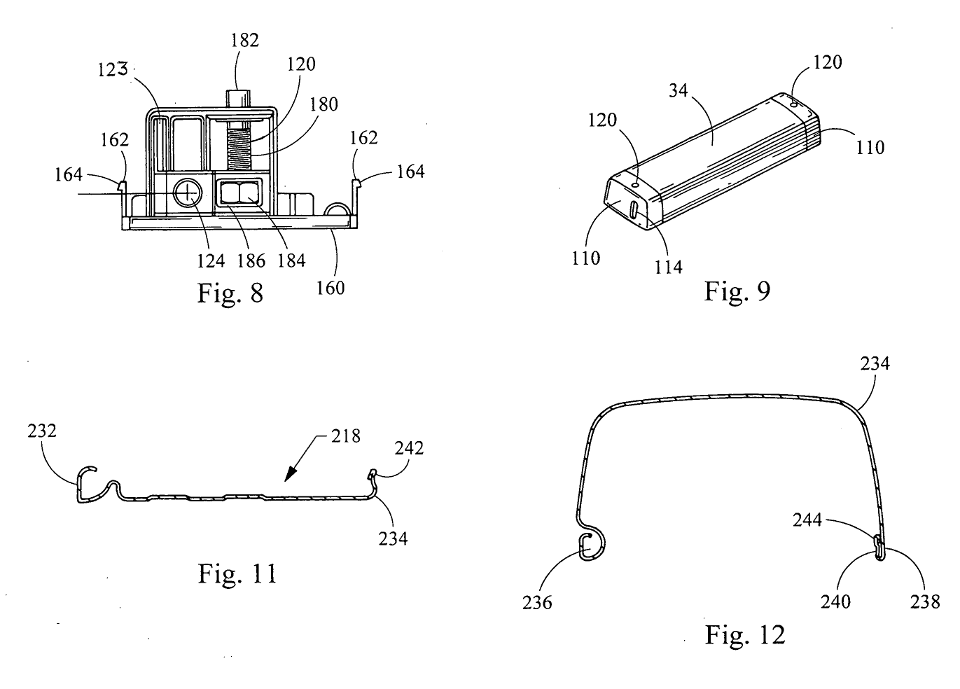

In one alternative embodiment, shown in FIGS. 7-10 and 13, a latch device 112 includes a housing having an upper portion 142 forming a cover with an outer end wall 110 having an opening 114 elongated in at least a first direction 116. The upper portion of the housing 142 is open opposite the end wall. A housing base 160, shown in FIG. 8, includes a pair of flexible, cantilever arms 162, each having a shoulder or tab portion 164, that engage a receiving portion on the upper portion with a snap-fit releasable engagement. Of course, it should be understood that the arms and receiving portion openings could be reversed, that the housing can be made as a single integral member, or that the two members can be joined by other devices, including bonding, mechanical fasteners, etc.

The upper portion includes a top and side walls 166, 168 joined to the outer end wall. The upper portion further is configured with a skirt 170 having a top and side walls 172, 174 that are each respectively recessed inwardly from the top and side walls 166, 168 so as to form a recess, or stepped surface, which receives the cover 234. Preferably, the cover has a thickness substantially the same as the depth of the recess such that the cover lies substantially flush with the top and side walls 166, 168 of the upper portion when the cover 234 is in the closed position to provide an aesthetically pleasing assembly.

A guide member 118 has a pair of guides that are adjustably moveable in a pair of tracks 120, 121 formed in a base 122 of the housing of the latch mechanism. The base 122 and upper portion 142 can be configured as right and left hand assemblies, which are a mirror image of each other. The guide member 118 can simply be rotated 180 degrees such that it is suitable for both the right and left hand assemblies. The base is mounted to the extension member 218, preferably releasably, for example with fasteners 178, a snap-fit or adhesive. In one embodiment, the base is configured with a U-shaped receptacle having an overhang or shoulder. A nut is shaped to be received in the receptacle and is retained by the shoulder and receptable in a non-rotational position such that it can be threadably engaged by a bolt or screw. The base 122 is covered by the housing 142. The guide member 118 is moveable relative to the base and housing along the first axis 116. The guide member 118 has an opening 124 substantially aligned with the elongated openings 114 in the housing 142 as the guide member 118 is moved relative to the base and housing in the first direction. An actuator 126, configured in one embodiment as a screw 180 with a grippable head portion 182, is rotatably mounted to one or both of the base and housing and is rotatable in first and second opposite rotation directions 128, 130. The head portion can be configured to receive a tool, for example with an internal opening shaped to receive a screw drive, hex or torque key wrench or other similar tool, or an exterior shaped to receive a socket or wrench. In one embodiment, the top surface of the head portion is substantially flush with the outer surface of the top 166 of the cover. The actuator 126 includes a threaded shaft 180 threadably engaged with a nut 184 non-rotatably secured in a hub portion 186 of the guide member, with the hub portion 186 acting as a guide that moves on one of the tracks 120. In other embodiments, threads are integrally formed in the guide member for engagement by the screw. The guide member includes a flange 188 that slides along a first track 120, while the hub slides along a second, rounded track 121.

In operation, the actuator is rotated in the first or second direction 128, 130. As the screw portion 180 threadably engages the guide member 124, or the nut 184 retained thereby, the guide member is translated or moved back and forth in the tracks 120, 121 along the first axis 116. It should be understood that the term “direction” as used herein can be mean movement along or about a respective axis.

A latch component 132, preferably configured as a rod, is coupled to the guide member by inserting the rod through the guide hole 124. The rod is reciprocally slidable 132 or moveable back and forth relative to the guide member along a second longitudinal axis 134. The second axis 134 is substantially perpendicular to the first axis 116.

In operation, the user rotates the actuator 120 to move the latch component 132 along the first axis 116 in a first direction to a predetermined position, e.g., height, in alignment, and for engagement, with a latch receiving element 136, for example an opening 138 formed in a frame structure of a doorway or truck bed. In this way, the latch device is modular and can be easily adjusted to accommodate various structures having latch receiving structures formed at different heights relative to the panel or other structure supporting the latch device. In addition, the actuator 120, and position of the rod 132, can be adjusted to accommodate for tolerances, such that the position of the latch component can be fine tuned for smooth operation and engagement with the latch-receiving structure.

In use, the operator moves an actuator 14 that moves the latch component 132 in the longitudinal direction along the axis 134, with the latch component extending out of the housing 110 through the opening 114 and into engagement with the latch-receiving structure 136. Since the opening 114 is elongated along the axis/direction 116 of adjustability, the opening 114 can accommodate the latch component in a variety of positions along the axis 116. In one embodiment, the latch device 112 is secured to the ends of the extension members 18, 218, with the linking rods also serving as the latch components.

In another embodiment, shown in FIGS. 10 and 11, the extension/mounting member 218 extends the entirety of the distance between the opposed latch devices. In this embodiment, a centrally located actuator mechanism (not shown in FIGS. 10 and 11) is simply bolted to the extension member at a predetermined position.

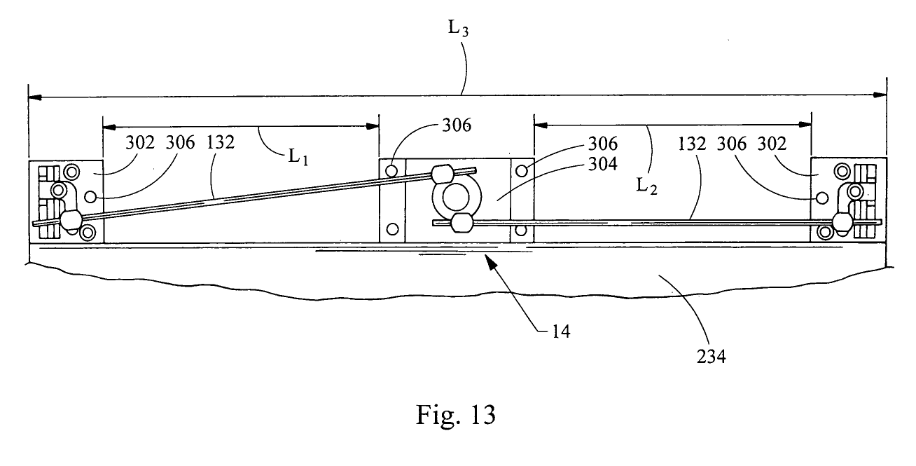

In yet another embodiment, shown in FIG. 13, three separate mounting members 302, 304 are each configured with fastener holes 306, or other devices such as adhesive or snap-fit members, such that the mounting members can be individually secured to the panel 2. The actuator mechanism 14 is secured to the center mounting member 304 to form a first module, while a pair of latch devices 112 are secured to the outer mounting members 304 to form a pair of second modules. Each of the mounting members can be formed from a length of extrusion (metal or plastic), or can be roll formed.

The linking rods are secured to the first and second modules such that the distances L1 and L2 are fixed, and such that the overall width (L3) of the assembly is fixed. When incorporating the latch devices of FIGS. 7 and 8 into the assembly of FIG. 13, the rods (and/or latch device) can be provided with a stop member to prevent them from being pulled out of the latch device, for example during shipping and installation. For example, a stop member can be secured to the rod between the housing outer wall and the guide member. Also, during operation, the actuator mechanism 14 or outside (operator) handle or lock cylinder 46 limit the rotation to 90° such that the rods are not disengaged from the latch device.

In other embodiments, the cover 34, 234 is hingedly secured to the first and second modules, so as to fix the distances L1, L2 and L3. In this embodiment, the cover and/or rods function as a connector or coupling between the modules, or extension members forming the base thereof. In this way, material costs can be reduced by using the shorter mounting members. The rods and/or the cover provide the rigidity and fixed length of the device such that the assembly can be easily installed without complicated measurement and assembly. Rather, the assembly is simply removed from the packaging and installed as a unit.

In operation, the modularity of the latch assembly 10 permits the manufacturer to easily modify the assembly for different size covers, doors etc., simply by varying the length of the extension members 18 and/or linking rods 38 (or latch components 132). In addition, the configuration of the assembly can be easily modified by substituting different actuator mechanisms 14 and latch devices 12, 112, which are configured to mate with the extension base members. The overall width and height of the assembly can also be easily and simply changed by providing different width extension members, base mounting members, covers etc. In this way, the assembly is provided with three-way modularity; (1) overall dimension (length, height and width), (2) alternative latch configurations and (3) alternative actuator configurations.

In addition, the latch assembly 10 can be preassembled at the manufacturer and shipped as an assembled unit. The end user, whether a single-purchase retail consumer or a cover/door manufacturer, can simply secure the assembly to the panel, for example with a plurality of fasteners 82 inserted through openings 80 formed in the extension member 18 or mounting member 16, rather than having to position and secure each component separately and then connect the components. Of course, the latch assembly can be secured in other ways, including snap-fit connections, welding or other bonding, including various adhesives. In any event, and as a result of the preassembly, the end user is not required to have exceptional installation skills and experiences considerable time savings in securing the latch assembly to the cover or door.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

1. A latch assembly comprising:
a mounting member having opposite first and second terminal end portions spaced apart in a longitudinal direction;
an actuator coupled to said mounting member, said actuator operable between at least a first and second position;
a first extension member having opposite first and second terminal end portions spaced apart a first fixed distance in said longitudinal direction, wherein said first terminal end portion of said first extension member is fixedly, non-moveably coupled to said first terminal end portion of said mounting member;
a second extension member having opposite first and second terminal end portions spaced apart a second fixed distance in said longitudinal direction, wherein said first terminal end portion of said second extension member is fixedly, non-moveably coupled to said second terminal end portion of said mounting member;
a first latch device coupled to said first extension member at a first location longitudinally spaced from said first terminal end portion of said first extension member, said first latch device operable between a latched and unlatched position; and
a second latch device coupled to said second extension member at a second location longitudinally spaced from said first terminal end portion of said second extension member, said second latch device operable between a latched and unlatched position, wherein said first and second latch devices are operatively coupled to said actuator and are moveable between said latched and unlatched positions as said actuator is operable between said first and second positions.

2. The latch assembly of claim 1 wherein said first and second fixed distances are substantially the same.

3. The latch assembly of claim 1 wherein one of said first terminal end portion of said mounting member and said first terminal end portion of said first extension member comprises at least one first insert portion and the other of said first terminal end portion of said mounting member and said first terminal end portion of said first extension member has at least one first opening shaped to receive said at least one first insert portion, and wherein one of said second terminal end portion of said mounting member and said first terminal end portion of said second extension member comprises at least one second insert portion and the other of said second terminal end portion of said mounting member and said first terminal end portion of said second extension member has at least one second opening shaped to receive said at least one second insert portion.

4. The latch assembly of claim 3 wherein said first and second terminal end portions of said mounting member comprise said first and second insert portions, and wherein said first terminal end portions of said first and second extension members have said at least said first opening and said at least said second opening respectively.

5. The latch assembly of claim 4 wherein said first and second extension members comprise extrusions having matching cross-sectional profiles defining said first and second openings.

6. The latch assembly of claim 3 wherein said at least one first insert portion comprises a plurality of first insert portions, wherein said at least one first opening comprises a plurality of first openings, wherein said at least one second insert portion comprises a plurality of second insert portions, and wherein said at least one second opening comprises a plurality of second openings.

7. The latch assembly of claim 1 further comprising a linking member connecting said actuator with each of said first and second latch devices.

8. The latch assembly of claim 7 wherein said linking member comprises first and second actuator rods connecting said actuator and said first and second latch devices respectively.

9. The latch assembly of claim 1 further comprising a cover hingedly connected to at least one of said mounting member and said first and second extension members.

10. The latch assembly of claim 9 wherein said at least one of said mounting member and said first and second extension members comprises an extrusion having a cross-sectional profile defining a first hinge portion, and wherein said cover comprises a second hinge portion hingedly connected to said first hinge portion.

11. The latch assembly of claim 9 wherein said cover couples said first terminal ends of said first extension member and said mounting member and wherein said cover couples said first terminal end of said second extension member and said second terminal end of said mounting member.

12. The latch assembly of claim 1 wherein said first and second extension are each configured with fastener openings shaped to receive mounting fasteners.

13. The latch assembly of claim 12 further comprising a panel fixedly secured to said first and second extension members with fasteners disposed through said fastener openings.

14. A vehicle comprising the latch assembly of claim 13, wherein said vehicle further comprises a support structure, wherein said panel is hingedly connected to said support structure of said vehicle.

15. A modular latch assembly kit comprising:
a mounting member having opposite first and second terminal end portions;
an actuator adapted to be coupled to said mounting member, said actuator operable between at least a first and second position;
a plurality of extension members each having first and second terminal end portions defining a length therebetween, wherein said length of at least one of said plurality of extension members is different than said length of at least another of said plurality of extension members, wherein said plurality of extension members are each configured to be coupled to at least one of said first and second terminal end portions of said mounting member; and
a latch device adapted to be coupled to at least one of said plurality of extension members.

16. The modular latch assembly kit of claim 15 wherein said mounting member comprises at least one insert portion extending from each of said first and second terminal end portions, and wherein each of said plurality of extension members has at least one opening shaped to receive said at least one insert portion.

17. The modular latch assembly kit of claim 16 wherein each of said plurality of extension members comprises an extrusion having a cross-sectional profile defining said at least one opening.

18. The modular latch assembly kit of claim 16 wherein said at least one insert portion comprises a plurality of insert portions, wherein said at least one opening comprises a plurality of openings.

19. The modular latch assembly kit of claim 15 further comprising a linking member adapted to connect said actuator with said latch device.

20. The modular latch assembly kit of claim 15 further comprising a cover adapted to be hingedly connected to at least one of said plurality of extension members.

21. A method of assembling a modular latch assembly comprising:
providing a mounting member having opposite first and second terminal end portions spaced apart in a longitudinal direction;
providing an actuator;
coupling said actuator to said first mounting member;
providing a first extension member;
coupling said first extension member to said first terminal end portion of said mounting member such that said first extension member extends from said mounting member in said longitudinal direction;
providing a second extension member;
coupling said second extension member to said second terminal end portion of said mounting member such that said second extension member extends from said mounting member in said longitudinal direction;
providing first and second latch devices;
coupling said first and second latch devices to said first and second extension members respectively; and
operably coupling said first and second latch devices to said actuator.

22. The method of claim 21 wherein said providing said first extension member comprises cutting an elongated extrusion to form said first extension member having a first length.

23. The method of claim 22 wherein said extrusion has a cross-sectional profile defining at least one opening, and wherein said mounting member has at least one insert portion, wherein said coupling said first extension member to said first terminal end portion of said mounting member comprises inserting said at least one insert portion into said at least one opening.

24. The method of claim 23 wherein said coupling said first extension member to said first terminal end portion of said mounting member further comprises fastening said first extension member to said mounting member after said inserting said at last one insert portion into said at least one opening.

25. The method of claim 23 wherein said cross-sectional profile further defines a first hinge portion, and further comprising hingedly connecting a second hinge portion of a cover to said first hinge portion, wherein said cover is moveable from a first position wherein at least a portion of said actuator and at least portions of said first and second latch devices are hidden from view to a second position wherein said at least said portion of said actuator and said at least portions of said first and second latch devices are exposed.

26. The method of claim 21 wherein said providing said first extension comprises cutting one or more elongated extrusions to form a plurality of extension members at least two of which have different lengths, and selecting one of said plurality of extension members as said first extension member.

27. The method of claim 21 wherein said providing said actuator comprises selecting said actuator from a plurality of actuators, wherein at least one of said plurality of actuators is different than at least one other of said plurality of actuators.

28. The method of claim 21 wherein said providing first and second latch devices comprises selecting said first and second latch devices from a plurality of latch devices, wherein at least one of said plurality of latch devices is different than at least one other of said plurality of latch devices.

29. The method of claim 21 further comprising mounting said first and second extension members to a panel.

30. The method of claim 29 wherein said mounting said first and second extension members to said panel comprises securing said first and second extension members to said panel with a plurality of fasteners.

31. The method of claim 29 wherein said mounting said first and second extension members to said panel is performed after said coupling said actuator to said first mounting member, after said coupling said first extension member to said first terminal end portion of said mounting member, after said coupling said second extension member to said second terminal end portion of said mounting member, and after said coupling said first and second latch assemblies to said first and second extension members respectively.

32-42. (canceled)
